(19) United States
(12) Patent Application Publication
(10) Pub. No.: US 2024/0314733 A1
(43) Pub. Date: Sep. 19, 2024

(54) METHOD, DEVICE AND COMPUTER READABLE MEDIUM FOR COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/577,148

(22) PCT Filed: Jul. 12, 2021
(86) PCT No.: PCT/CN2021/105749

§ 371 Date: Jan. 5, 2024

(51) Int. Cl. H04W 68/02; H04W 52/02

(52) U.S. Cl. CPC H04W 68/02; H04W 52/0212

(57) ABSTRACT

Embodiments of the present disclosure relate to methods, devices and computer readable media for communication. According to embodiments of the present disclosure, a terminal device receives, from a network device, a list of minimum discontinuous reception (DRX) cycles associated with a plurality of paging carriers. The terminal device selects a paging carrier from the plurality of paging carriers. The terminal device determines a DRX cycle based on at least one of a DRX cycle specific to the terminal device and a minimum DRX cycle associated with the paging carrier in the list of minimum DRX cycles.

### FIELD

Embodiments of the present disclosure generally relate to the field of communication, and in particular, to a method, device and computer readable medium for communication.

### BACKGROUND

To improve the efficiency of the Internet of Things (IoT) technology, studies has been made to optimize the way of paging for different terminal devices having different communication requirements.

Conventionally, the DRX cycle for monitoring the frequency resources selected by the terminal equipment may be determined inappropriately. For example, it may cause a UE to generate meaningless power waste or the paging requirement specific to a UE cannot be fulfilled.

### SUMMARY

In general, example embodiments of the present disclosure relate to methods, devices and computer readable media for communication.

In a first aspect, there is provided a method implemented by a terminal device. In the method, the terminal device receives, from a network device, discontinuous reception (DRX) information, the DRX information at least comprising a minimum DRX cycle associated with a first frequency resource. Then, the terminal device determines a target DRX cycle based on a DRX cycle specific to the terminal device and the minimum DRX cycle.

In a second aspect, there is provided a method implemented by a terminal device. In the method, the terminal device receives, from a network device, discontinuous reception (DRX) information, the DRX information at least comprising a DRX cycle associated with a first frequency resource. Then, the terminal device determines a target DRX cycle based on at least one of a DRX cycle specific to the terminal device and the DRX cycle.

In a third aspect, there is provided a method implemented by a terminal device. In the method, the terminal device sends a first indication of the first criteria to a network device. Then, the terminal device monitors a first frequency resource, and the first frequency resource is selected from a plurality of frequency resources based on the first criteria.

In a fourth aspect, there is provided a method implemented by a network device. In the method, a network device determines a first criteria used by a terminal device to select a frequency resource from a plurality of frequency resources. Then, the network device selects, for the terminal device, the frequency resource from the plurality of frequency resources based on the first criteria.

In a fifth aspect, there is provided a method implemented by a core network (CN) device. In the method, the CN receives, from a first network device, a first indication of a first criteria for selecting a paging carrier from a plurality of paging carriers for a terminal device. Then, the CN sends the first indication of the first criteria to a second network device associated with the terminal device

In a fifth aspect, there is provided a terminal device. The terminal device comprises circuitry configured to perform the method of any one of the first aspect, the second aspect or the third aspect.

In the sixth aspect, there is provided a network device. The network device comprises circuitry configured to perform the method of the fourth aspect.

In the seventh aspect, there is provided a CN device. The CN device comprises circuitry configured to perform the method of the fifth aspect.

In the eighth aspect, there is provided a computer readable medium having instructions stored thereon, the instructions, when executed on at least one processor, causing the at least one processor to perform the method of any one the first aspect to the fifth aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates a diagram of overlapping between a DRX cycle and paging Common Search Space (CSS);

FIG. 2 illustrates an example environment in which example embodiments of the present disclosure can be implemented;

FIG. 3 illustrates signaling diagram for determining DRX cycle according to example embodiments of the present disclosure;

FIG. 4 illustrates an example of DRX information comprising a plurality of minimum DRX cycles associated with respective paging carriers according to example embodiments of the present disclosure;

FIG. 5A-FIG. 5C illustrate examples of DRX cycle determined based on at least one of minimum DRX cycle specific to paging carrier, DRX cycle specific to a terminal device and default according to example embodiments of the present disclosure;

FIG. 6 illustrates an example of DRX information comprising a plurality of DRX cycles associated with respective paging carriers according to example embodiments of the present disclosure;

FIG. 7A-FIG. 7C illustrate examples of DRX cycle determined based on at least one of DRX cycle specific to paging carrier and DRX cycle specific to a terminal device according to example embodiments of the present disclosure;

FIG. 8 illustrates an example alignment between a terminal device, network devices and a core network according to example embodiments of the present disclosure;

FIG. 9 illustrates an example alignment between a terminal device, network devices and a core network according to example embodiments of the present disclosure;

FIG. 10 illustrates a simplified block diagram of a device that is suitable for implementing example embodiments of the present disclosure.

FIG. 11 illustrates a flow chart of an example method of communication implemented at a terminal device in accordance with some embodiments of the present disclosure;

FIG. 12 illustrates a flow chart of an example method of communication implemented at a terminal device in accordance with some embodiments of the present disclosure;

FIG. 13 illustrates a flow chart of an example method of communication implemented at a network device in accordance with some embodiments of the present disclosure; and

FIG. 14 illustrates a flow chart of an example method of communication implemented at a network device of core network in accordance with some embodiments of the present disclosure; and

FIG. 15 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, in and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the term “frequency resource” refers to a frequency resource unit in communication network, for example, a carrier in narrow band (NB) IoT, a narrow band in LTE enhanced MTC (eMTC), a bandwidth part in 5G communication and any resource

As used herein, the term “DRX cycle specific to a terminal device” refers to UE specific DRX value, or any DRX cycle reflecting requirements of terminal device.

Conventionally, in a IoT communication network, a terminal device may monitor for a paging occasion (PO) located in a common search space (CSS) with a discontinuous reception (DRX) cycle to determine the subsequent operations, for example, transitioning to active mode for data transmission or maintaining within an idle mode for energy saving. However, there may be different communication requirements specific to different Terminal devices, for example, a terminal device for autonomous vehicle driving may require ultra-low latency and operate in good coverage but terminal device for water meters and electric meters may be not. To fulfill requirements for paging latency, terminal device may have a specified DRX cycle. And for terminal device with poor coverage, paging repetition may needed for coverage enhancement. Consider that once the DRX cycle for a terminal device is not determined appropriately, for example, in the case where deep coverage is supported on the selected paging carrier so that the paging CSS repetition duration is longer than the DRX cycle used by a terminal device, the adjacent CSS repetition durations for the terminal device may be overlapping with each other. In other words, the terminal device will start monitoring PO belonging to next DRX cycle while previous paging CSS repetition are not finished. In another case where the terminal device use DRX cycle which is much longer than the paging CSS repetition duration to avoid paging CSS overlapping mentioned above, the latency of paging for the terminal maybe not fulfill the requirement.

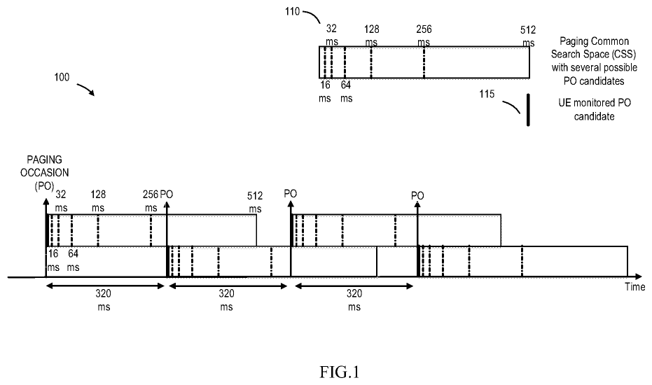

FIG. 1 illustrates overlapping between a DRX cycle used by a terminal device and paging Common Search Space (CSS).

In FIG. 1, the DRX cycle of terminal device may be 320 ms and is shorter than the duration of CSS of the paging carrier monitored by the terminal device, the duration of CSS has multiple candidates of paging occasions for being monitored by served terminal devices, and the served terminal devices monitors a certain paging occasion in CSS allocated to these terminal devices with DRX cycle. Conventionally, if the minimum DRX cycle specified to terminal device is too long, the longer paging latency will be resulted; if the minimum DRX cycle specified to terminal device is too short, DRX cycle used by certain terminal devices may overlap with CSS.

As discussed above, the conventional DRX cycle determination method has defects, which may cause longer latency or an overlap between the DRX cycle of the terminal device and the CSS duration of the paging carrier.

According to embodiments of present disclosure, a method for overcoming the above defects is provided. In this method, in the situation of multi-carrier operation, terminal device and network device may determine a target DRX cycle based on a DRX cycle specific to the terminal device and a minimum DRX cycle associated with the paging carrier. In this method, terminal device receives discontinuous reception (DRX) information from a network device, the DRX information at least comprising a minimum DRX cycle associated with a first frequency resource. Then, the terminal device determines a target DRX cycle based on a DRX cycle specific to the terminal device and the minimum DRX cycle. In this method, by means of information on the minimum DRX cycles associated with the paging carrier, the target DRX cycle for a paging carrier may be determined suitably, such that the terminal device is able to monitor the paging occasion using the target DRX cycle, to avoid the overlapping between the target DRX cycles used by the terminal devices and CSS of the paging carrier, and fulfill different requirements of different Terminal devices.

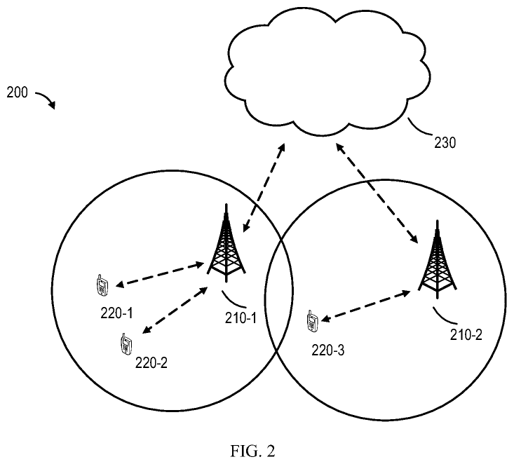

Some embodiments according to the present disclosure will be described in more detail with reference to FIGS. 2-15 in the following.

FIG. 2 illustrates an example environment in which example embodiments of the present disclosure can be implemented.

The environment 200, which may be a part of a communication network, comprises a network device 210-1 and a network device 210-2, as well as a terminal device 220-1, terminal device 220-2, and a terminal device 220-3. For sake of discussion, the network device 210-1 and the network device 210-2 may be collectively referred to as “network device 210”, and the terminal device 220-1, the terminal device 220-2 and the terminal device 220-3 may be collectively referred to as “terminal device 220”. The terminal device 120 may communicate with a CN device 230 via the network device 110.

It is to be understood that three terminal devices and two network devices are shown in the environment 200 only for the purpose of illustration, without suggesting any limitation to the scope of the present disclosure. In some example embodiments, the environment 200 may comprise a further terminal device to communicate information with a further network device.

The communications in the environment 200 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

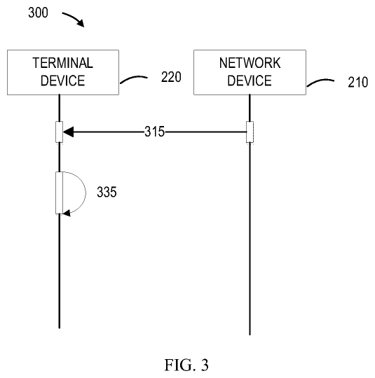

FIG. 3 illustrates signaling diagram for determining target DRX cycle according to example embodiments of the present disclosure. In the signaling diagram 300, according to example embodiments of the present disclosure, terminal device 220 receives (315) DRX information from a network device 210, the DRX information at least comprising a minimum DRX cycle associated with a first frequency resource. For the sake of discussion, in the context of the present disclosure, the frequency resource which is selected and monitored finally by the terminal device is referred as the first frequency resource.

In some embodiments, the terminal device 220 receives DRX information in at least one of System Information Block (SIB) 2 and System Information Block (SIB) 22.

Alternatively, in some embodiments, the terminal device 220 receives DRX information comprising minimum DRX cycles in SIB 22. For example, the terminal device 220 receives the minimum DRX cycle associated with the anchor-carrier in SIB 22, and further receives minimum DRX cycles associated with non-anchor-carriers in a paging carrier list in SIB 22.

Alternatively, in some embodiments, the terminal device 220 receives a minimum DRX cycle associated with the anchor-carrier in RadioResourceConfigCommonSIB-NB of the SIB 2 (system information block (SIB) 2) and further receives minimum DRX cycles associated with non-anchor-carriers in the paging carrier list in SIB 22.

Moreover, the paging carrier list may be included in SIB 22 as a list of Downlink (DL) Configuration Common-Narrow Band (DL Configuration Common List Narrow Band (NB)). In addition, PCCH configuration may be comprised in Downlink (DL) Configuration Common-Narrow Band, and DRX information comprising minimum DRX cycles may be included in PCCH configuration (PCCH-config).

In some alternative embodiments, the terminal device 220 receives (315) a frequency resource list comprising one or more minimum DRX cycles associated with respective frequency resources from network device 210. In an example of the embodiment, the frequency resource list may also be received as the paging carrier list.

In some embodiments, terminal device 220 receives (315) the DRX information in at least one of a System Information Block (SIB) (e.g., SIB 22) or Radio Resource Control (RRC) signaling from network device 210.

According to example embodiments of the present disclosure, terminal device 220 determines (335) a target DRX cycle based on a DRX cycle specific to the terminal device and the minimum DRX cycle. Then, the terminal device 220 may monitor at the paging occasions (PO) on the first frequency resource with the target DRX cycle, such that avoiding the overlapping between the CSSs belonging to adjacent DRX cycles.

In some embodiments, the DRX information comprises a plurality of minimum DRX cycles associated with a plurality of frequency resources. As an example, the DRX information comprising the plurality of minimum cycles may be included the paging carrier, and a certain minimum DRX cycle may be included in the configuration of associated paging carrier in the paging carrier list.

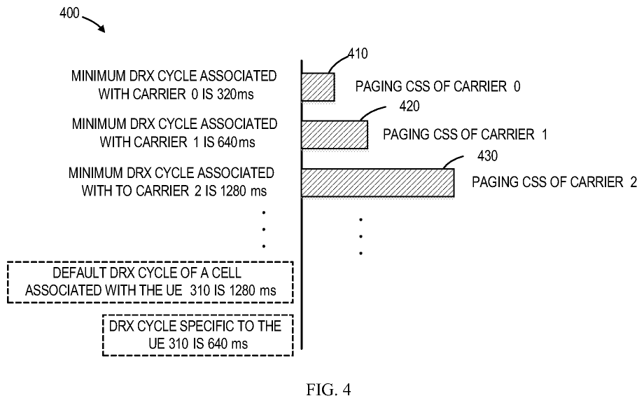

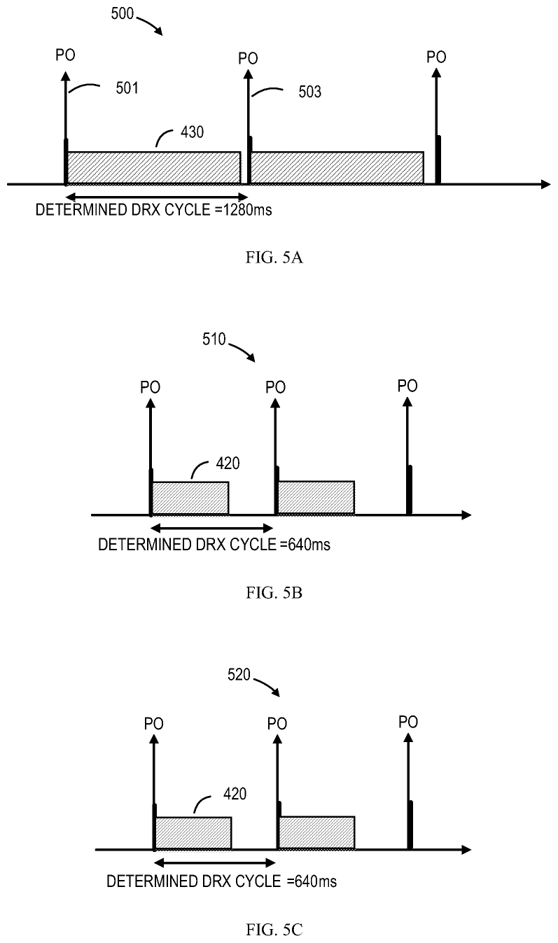

For the purpose of discussion, the detail description of the determination of the DRX cycle will be described with reference to FIG. 4 and FIGS. 5A-5C. FIG. 4 illustrates an example of DRX information 400 comprising plurality of minimum DRX cycles associated with respective paging carriers according to example embodiments of the present disclosure. As an example and without any limitation, FIG. 4 and FIGS. 5A-5C illustrate the determination process of target DRX cycle in a NB-IoT communication system according the embodiments of present disclosure, and thereby the frequency resources is shown as a paging carrier. In other communication systems, the frequency may also be shown as a narrow band (in LTE enhanced MTC (eMTC)), a bandwidth part (in 5G communication) and any resource capable of being used for paging terminal device.

In the example DRX information 400, without suggesting any limitation as to the scope of the disclosure, three minimum DRX cycles associated with three paging carrier, i.e., Carrier 0, 1 and 2, are shown, and Carrier 0, 1 and 2 may be associated with different coverage levels. Schematically, the corresponding CSS 410, 420 and 430 corresponding to these carriers is illustrated on the right. In exemplary embodiment of FIG. 4, assuming minimum DRX cycles associated with Carrier 0, 1 and 2 are 320 ms, 640 ms and 1280 ms respectively, default DRX cycle of a cell associated with the terminal device 220 is 1280 ms and DRX cycle specific to terminal device 220 is 640 ms. Without any limitation, the value of DRX cycle associated with frequency resource, or the value of DRX cycle specified to terminal devices, or the value of the default DRX cycle of a cell in the present disclosure is only an example, and any other values of DRX cycle can be employed.

In some embodiments, the number of the plurality of paging carriers may be one, in this case, this one paging carrier is the paging carrier that selected and monitored by the terminal device 220, as discussed above, this one paging carrier is also referred the first paging carrier. Then, the terminal device 220 determines the target DRX cycle by: determining a maximum of the DRX cycle specific to the terminal device 220 and the minimum DRX cycle associated with the first frequency resource; and determining a minimum of a default DRX cycle and the determined maximum as the target DRX cycle.

As an example, if the DRX information 400 only comprise the minimum DRX cycle, for example 32 ms, associated with Carrier 0, then the target DRX cycle may be determined by: determining a maximum, for example 70 ms, of the DRX cycle specific to the terminal device 220 and the minimum DRX cycle associated with the first frequency resource; and determining a minimum of a default DRX cycle and the determined maximum as the target DRX cycle, for example, 70 ms.

Without any limitation, the value of DRX cycle associated with frequency resource, or the value of DRX cycle specified to terminal devices, or the value of the default DRX cycle of a cell in the present disclosure is only an example, and any other values of DRX cycle can be employed.

Returning to the example of DRX information comprising three minimum DRX cycles associated with three paging carrier.

In some embodiments, the terminal device 220 may select the first paging carrier from the plurality of paging carrier only based on coverage level associated with the terminal device 220, terminal device 220 may determine a set of paging carriers comprising the paging carriers, associated with the coverage level selected by the terminal device 220, from the plurality of paging carrier. In some embodiments, terminal device 220 may determine a set of paging carriers comprising the paging carriers, capable of supporting the coverage level selected by the terminal device 220, from the plurality of paging carrier. In some embodiments, terminal device 220 may determine a set of paging carriers comprising the carriers, associated with the coverage level higher than or equal to the selected coverage level, from the plurality of paging carrier. In some embodiments, terminal device 220 may also use other criterions to select the set of paging carriers.

In some embodiments, the terminal device 220 then may randomly select a paging carrier from the determined set of paging carriers as the first paging carrier. For example, in 3GPP 36,604, the paging carrier with smallest index n fulfilling the following equation may be determined as the first paging carrier:

$$Floor ( UE\_ID / ( N * Ns ) ) mod W < W ( 0 ) + W ( 1 ) + W ( 2 ) + … + W ( n ) ; \qquad ( 1 )$$

wherein W represents total weight of all NB-IoT paging carriers in selected set of paging carrier. In some embodiments, the terminal device 220 then may arbitrary select a paging carrier from the determined set of paging carriers.

In the embodiment where the first paging carrier is selected only based on coverage level associated with the terminal device 220, after the first paging carrier is selected, the terminal device 220 determines the target DRX cycle by: determining a maximum of the DRX cycle specific to the terminal device 220 and the minimum DRX cycle associated with the first paging carrier; and determining a minimum of a default DRX cycle and the determined maximum as the target DRX cycle.

In example of this embodiment, after terminal device selects a set of paging carriers only based on coverage level associated with the terminal device 220, for example, Carrier 1 and Carrier 2 are selected, terminal device may randomly selects Carrier 2 as the first paging carrier. In this case, DRX cycle may be determined by: determining a maximum (i.e., 1280 ms) of the DRX cycle, for example 640 ms, specific to the terminal device 220 and the minimum DRX cycle, for example 1280 ms, associated with the first paging carrier (Carrier 2); and determining a minimum (i.e., 1280 ms) of a default DRX cycle, for example 1280 ms, and the determined maximum, for example 1280 ms, as the target DRX cycle.

For example, the target DRX cycle T may be determined by the following equation (2):

$$T = min ( {T}_{default DRX} , max ( {T}_{UE specific DRX} , {T}_{minimum DRX of selected carrier} ) ) \qquad ( 2 )$$

wherein T_{default DRX} represents the default DRX cycle, T_{UE specific} DRA represents the DRX cycle specific to the terminal device 220 and T_{minimum DRX of selected carrier} represents the minimum DRX cycle associated with the first paging carrier broadcast in the system information.

FIG. 5A-FIG. 5C illustrates examples of target DRX cycle determined based on minimum DRX cycle associated with the first paging carrier, DRX cycle specific to the terminal device 220 and default DRX cycle according to example embodiments of the present disclosure.

FIG. 5A illustrates the relation between the CSS of the selected first paging carrier-Carrier 2 and the PO/DRX cycle determined based on minimum DRX cycle associated with Carrier 2, DRX cycle specific to a terminal device 220 and default DRX cycle, in the embodiment where selecting the first paging carrier only based on coverage level. As can be seen, by means of information on the minimum DRX cycles associated with paging carriers, the target DRX cycle be determined suitably, to avoid the overlapping between DRX cycles specified to the terminal device 220 selected the first paging carrier and CSS of the first paging carrier. In FIG. 5A, in the schematic diagram 500, the terminal device may monitor at the PO on the first paging carrier, Carrier 2, with the determined target DRX cycle, 1280 ms, such that avoiding the overlapping between the CSSs belonging to adjacent DRX cycles.

Returning to FIG. 4, in some embodiments, terminal device 220 may select a paging carrier from the plurality of paging carrier based on coverage level associated with the terminal device 220 and DRX value specified to the terminal device 220. In this embodiment, terminal device 220 may first determine a set of paging carriers, associated with the coverage level selected by the terminal device 220, from the plurality of paging carrier. In this embodiment, terminal device 220 may determine a set of paging carriers from the plurality of paging carriers in the same way of the embodiment where selecting the first paging carrier only based on the coverage level associated with the terminal device 220.

Then, for each one of the set of paging carriers, terminal device calculates the difference between the minimum DRX cycle associated with the paging carrier and DRX specific to the terminal device 220. With reference to FIG. 4, only as an example, assuming that the set of paging carriers comprises Carrier 0, Carrier 1 and Carrier 2, through the above calculation, terminal device may obtain three differences of Carrier 0, Carrier 1 and Carrier 2. The difference of Carrier 0 is |640 ms−320 ms|=320 ms, the difference of Carrier 1 is Oms and the difference of Carrier 2 is 640 ms.

In some embodiments, the calculated differences may be ranked in the order from the smallest one to the largest one, such that showing the relative distance between the minimum DRX cycle associated with each paging carrier in the set and the DRX cycle specified to the terminal device 220.

In some embodiments, the terminal device 220 may select the paging carrier with the smallest difference as the paging carrier to be used. In some embodiments, if the differences are ranked in the order from the smallest one to the largest one, the terminal device 220 may select the paging carrier corresponding to the difference in the first order as the first paging carrier.

In some embodiments, the terminal device 220 may determine one or more paging carriers corresponding to one or more the smallest differences and select a paging carrier corresponding to the difference below a certain threshold as the first paging carrier. For example, the terminal device 220 may first determine the smallest difference (may be referred as the smallest difference) and a paging carrier corresponding to this difference, and then determine the smallest difference (may be referred as the second smallest difference) of the remaining differences other than the first difference corresponding to the first carrier, and another paging carrier corresponding to the second smallest difference. Then, the terminal device 220 may determine the second smallest difference as the threshold, in this case, selecting a paging carrier corresponding to the difference below this threshold means that selecting a paging carrier associated with the minimum DRX cycle closest to the DRX cycle specified to the terminal device 220 as the first paging carrier.

In some embodiments, terminal device 220 may also determine a smallest difference (may be referred as the third smallest difference) of the remaining differences other than the smallest difference and second smallest difference, and then determine the third smallest difference as the threshold. In this case, selecting paging carriers corresponding to the differences below this threshold means that selecting two paging carriers associated with the two minimum DRX cycles closest to the DRX cycle specified to the terminal device 220. Then, terminal device 220 may select one of these two paging carriers as the first paging carrier as demand.

In some embodiments, the terminal device 220 may also determine other thresholds.

With reference to FIG. 4, in the case where the threshold is the second smallest difference, terminal device may select Carrier 1 as the first paging carrier, that is, the paging carrier associated with minimum DRX cycle (640 ms) closest to DRX cycle (640 ms) specified to terminal device 220 is selected. Alternatively, as discussed above, terminal device 220 may also select the paging carrier associated with minimum DRX cycle closest to DRX cycle specified to terminal device 220 in ranking method.

In the embodiment where the paging carrier associated with minimum DRX cycle closest to DRX cycle specified to terminal device 220 is selected as the first paging carrier, the DRX cycle may be determined by the terminal device 220 through the following steps: determining a maximum of the DRX cycle specific to the terminal device 220 and the minimum DRX cycle specific to the paging carrier; and selecting a minimum of a default DRX cycle and the determined maximum as the target DRX cycle. Similarly, in this embodiment, once the first paging carrier is selected, the target DRX cycle may also be determined by the equation (2).

FIG. 5B illustrates the relation between the CSS of selected paging carrier-Carrier 1 and the DRX cycle determined based on minimum DRX cycle associated with paging carrier, DRX cycle specific to a terminal device and default DRX cycle, in the embodiment where the paging carrier associated with minimum DRX cycle closest to DRX cycle specified to terminal device 220 is selected as the first paging carrier. In this case, the paging carrier (Carrier 1) which associated minimum DRX cycle closest to DRX cycle specific to the terminal device 220 is selected as the first paging carrier, and with the determination of DRX cycle, the target DRX cycle is determined as 640 ms, and the overlapping can be avoided. Therefore, a trade-off is achieved between the communication efficiency and terminal device requirements. In FIG. 5B, in the schematic diagram 510, the terminal device 220 may monitor at the PO on the first paging carrier, Carrier 1, with the determined target DRX cycle, 640 ms, such that avoiding the overlapping between the CSSs belonging to adjacent DRX cycles, while the requirement of the terminal device 220 can be fulfilled.

In some embodiments, terminal device 220 may select a paging carrier whose associated minimum DRX cycle is equal to or shorter than the DRX cycle specific to the terminal device as the first paging carrier.

In some embodiments, after the calculated differences are ranked in the order from the smallest one to the largest one, terminal device 220 may find the differences which the corresponding minimum DRX cycle is shorter than or equal to the DRX cycle specific to the terminal device 220, and determine the difference ranked in the first in the find differences. Then the paging carrier which associated minimum DRX cycle corresponds to this ranked first difference is selected as the first paging carrier. For example, with reference to FIG. 4, Carrier 0, 1, 2 is ranked to be the order: Carrier 1, for example 640 ms, Carrier 0, for example 320 ms, Carrier 2, for example 1280 ms, in this case, Carrier 1 is selected as the first paging carrier. It means that the paging carrier which associated minimum DRX cycle closest to, and shorter than or equal to the DRX cycle specific to the terminal device 220 is selected as the first paging carrier.

In some embodiments, as discussed above, when terminal device determining one or more paging carriers by means of certain threshold, terminal device may dynamically modifies the threshold until firstly existing the difference corresponding to the minimum DRX cycle associated with a certain paging carriers fulfills the threshold (i.e., below the threshold), and DRX cycle associated with the certain paging carrier is shorter or equal to the DRX cycle specific to the terminal device 220. Then, terminal device 220 selects the certain paging carrier as the first paging carrier. With reference to FIG. 4, Carrier 1 is selected as the first paging carrier. Similarity, it means that the paging carrier which associated minimum DRX cycle closest to, and shorter or equal to the DRX cycle specific to the terminal device 220 is selected as the first paging carrier.

In the embodiment where the paging carrier associated with minimum DRX cycle closest to DRX cycle, and shorter than or equal to the DRX cycle specified to terminal device 220 is selected, the DRX cycle may be determined by terminal device 220 through the following steps: selecting a minimum of a default DRX cycle and the DRX cycle specified to terminal device 220 as the target DRX cycle.

FIG. 5C illustrates the relation between the CSS of selected paging carrier-Carrier 1 and the DRX cycle determined based on minimum DRX cycle associated with paging carrier, DRX cycle associated with a terminal device, in the embodiment where the paging carrier associated with minimum DRX cycle closest to DRX cycle, and shorter than or equal to the DRX cycle specified to terminal device 220 is selected. In this case, the paging carrier (Carrier 1) which associated minimum DRX cycle closest to, and shorter than or equal to DRX cycle specified to the terminal device 220 is selected as the first paging carrier, and with the determination of DRX cycle, the overlapping can be avoided. Therefore, a trade-off is achieved between the communication efficiency, and the terminal device requirement being more considered. In FIG. 5C, in the schematic diagram 520, the terminal device 220 may monitor at the PO on the first paging carrier, Carrier 1, with the determined target DRX cycle, 640 ms, such that avoiding the overlapping between the CSSs belonging to adjacent DRX cycles, while the requirement of the terminal device 220 being more considered.

In some embodiments, terminal device 220 may select a paging carrier only based on DRX cycle specific to the terminal device 220. In this situation, terminal device 220 may select the first paging carrier from the plurality of carriers only based on DRX cycle specific to the terminal device 220. As discussed above, terminal device 220 may directly select the first paging carrier from the plurality of paging carriers whose minimum DRX cycle closest to the DRX cycle specific to the terminal device 220 by means of ranking or a suitable threshold. In some embodiments, terminal device 220 may also directly select the first paging carrier from the plurality of paging carriers whose minimum DRX cycle closest to, and shorter than or equal to the DRX cycle specific to the terminal device 220 by means of ranking or a suitable threshold.

In the embodiment where selecting the first paging carrier only based on DRX cycle specified to the terminal device 220, the DRX cycle may be determined by terminal device 220 through the following steps: determining a maximum of the DRX cycle specific to the terminal device and the minimum DRX cycle specific to the paging carrier; and selecting a minimum of a default DRX cycle and the determined maximum as the DRX cycle to be used. For example, with reference to FIG. 4, if Carrier 1 is selected as the first paging carrier (its associated DRX cycle is closest to the DRX cycle specific to the terminal device 220 in Carrier 0, 1 and 2), the target DRX cycle is calculated as 640 ms.

With those embodiments above, the target DRX cycle may be determined more flexible, considering the minimum DRX cycles associated with the frequency resources.

According to embodiments of present disclosure, another method for overcoming the above defects is provided. In this method, in the situation of multi-carrier operation, terminal device and network device may determine DRX cycle based on at least one of a DRX cycle specific to the terminal device and a DRX cycle associated with the first frequency resource. In this method, terminal device receives, from a network device, DRX information, the DRX information at least comprising a DRX cycle associated with a first frequency resource. Then, terminal device determines a target DRX cycle based on at least one of a DRX cycle specific to the terminal device and the DRX cycle. In this method, by means of information on the DRX cycles associated with the first frequency resource, the target DRX cycle may be determined suitably, to avoid the overlapping between DRX cycles specified to terminal device selected the first paging carrier and CSS of the first paging carrier, and fulfill different requirements of different terminal devices.

This method is discussed still with reference to FIG. 3. In the signaling diagram 300, according to example embodiments of the present disclosure, terminal device 220 receives (315) DRX information from a network device 210, the DRX information at least comprising a DRX cycle associated with a first frequency resource.

In some embodiments, the terminal device 220 receives DRX information in at least one of System Information Block (SIB) 2 and System Information Block (SIB) 22.

Alternatively, in some embodiments, the terminal device 220 receives DRX information comprising DRX cycles in SIB 22. For example, the terminal device 220 receives the DRX cycle associated with the anchor-carrier in SIB 22, and further receives DRX cycles associated with non-anchor-carriers in a paging carrier list in SIB 22.

Alternatively, in some embodiments, the terminal device 220 receives a DRX cycle associated with the anchor-carrier in RadioResourceConfigCommonSIB-NB of the SIB 2 (system information block (SIB) 2), and further receives DRX cycles associated with non-anchor-carriers in the paging carrier list in SIB 22.

Moreover, the paging carrier list may be included in SIB 22 as a list of Downlink (DL) Configuration Common-Narrow Band (DL Configuration Common List Narrow Band (NB)). In addition, PCCH configuration may be comprised in Downlink (DL) Configuration Common-Narrow Band, and DRX information comprising DRX cycles may be included in PCCH configuration (PCCH-config).

In some embodiments, the terminal device 220 receives (315) a frequency resource list comprising one or more DRX cycles associated with respective frequency resources from network device 210. In an example of the embodiment, the frequency resource list may also be received as the paging carrier list.

In some embodiments, terminal device 220 receives (315) the DRX information in at least one of a System Information Block (SIB) (e.g., SIB 22) or Radio Resource Control (RRC) signaling from network device 210.

According to example embodiments of the present disclosure, terminal device 220 determines (335) a target DRX cycle based on a DRX cycle specific to the terminal device and the DRX cycle. Then, the terminal device 220 may monitor the first frequency resource at the paging occasions (PO) having the target DRX cycle, such that the avoiding the overlapping between the CSS of the first frequency resource and the POs/DRX cycles.

In some embodiments, the DRX information comprises a plurality of DRX cycles associated with a plurality of frequency resources. As an example, the DRX information comprising the plurality of cycles may be included the paging carrier, and a certain DRX cycle may be included in the configuration of associated paging carrier in the paging carrier list.

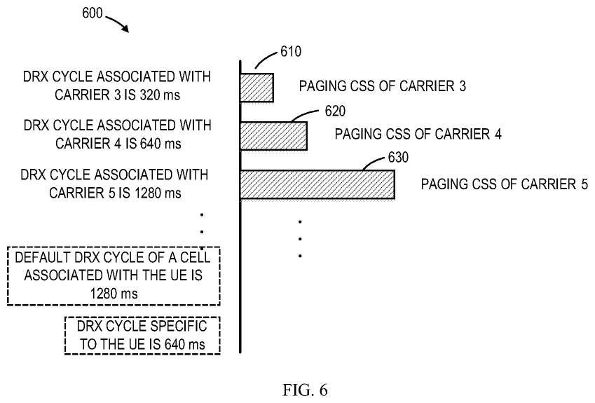

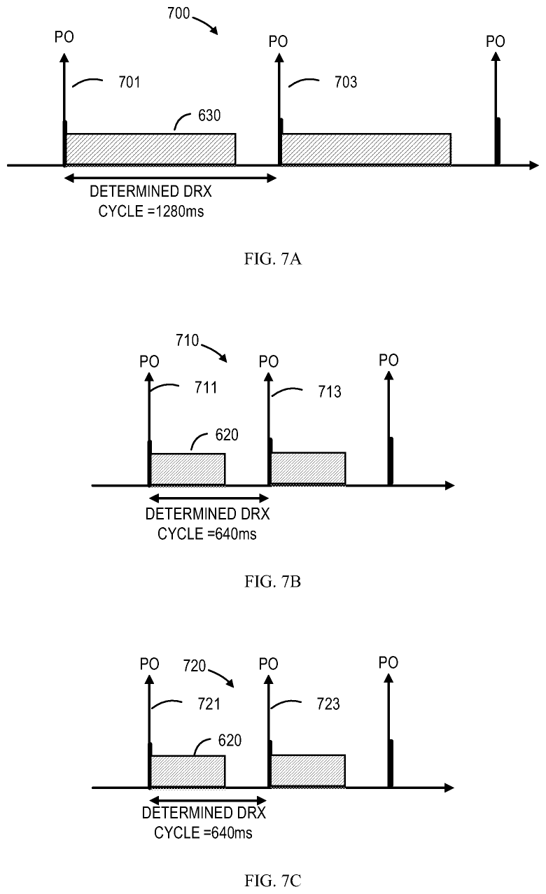

For the purpose of discussion, the detail description of the determination of the DRX cycle will be described with reference to FIG. 6 and FIGS. 7A-7C. FIG. 6 illustrates an example of DRX information 600 comprising plurality of DRX cycles associated with a plurality of paging carriers according to example embodiments of the present disclosure. As an example and without any limitation, FIG. 6 and FIGS. 7A-7C illustrate the determination process of target DRX cycle in a NB-IoT communication system according the embodiments of present disclosure, and thereby the frequency resources is shown as a paging carrier. In other communication systems, the frequency may also be shown as a narrow band (in LTE enhanced MTC (eMTC)), a bandwidth part (in 5G communication) and any resource capable of being used for paging terminal device.

In some embodiments, the number of the plurality of paging carriers may be one, in this case, this one paging carrier is the paging carrier that selected and monitored by the terminal device 220, as discussed above, this one paging carrier is also referred the first paging carrier. Then, the terminal device 220 determines the target DRX cycle by: determining the DRX cycle associated with the first paging carrier as the target DRX cycle.

As an example, if the DRX information 600 only comprise the DRX cycle, for example 320 ms, associated with Carrier 3, then the target DRX cycle may be determined by: determining the DRX cycle associated with the first paging carrier (Carrier 3) as the target DRX cycle, for example 320 ms.

Returning to the example of DRX information comprising three DRX cycles associated with three paging carrier.

In some embodiments, terminal device 220 may select the first paging carrier from the plurality of paging carrier only based on coverage level associated with terminal device 220. In some embodiments, terminal device 220 may also select the first paging carrier from the plurality of paging carrier based on coverage level associated with terminal device 220 and DRX cycle specified to the terminal device 220. In some embodiments, terminal device 220 may also select the first paging carrier from the plurality of paging carrier only based on DRX cycle specified to the terminal device 220.

In some embodiments, terminal device may select the first paging carrier only based on the coverage level in the same way of the embodiment where selecting the first paging carrier only based on the coverage level discussed above regarding the DRX information comprising minimum DRX cycle associated paging carrier. In some embodiments, in the embodiment where selecting the first paging carrier based on the coverage level associated with the terminal device 220 and the DRX cycle specified to the terminal device 220, terminal device may select the first paging carrier in the same way of the embodiment where selecting the first paging carrier based on coverage level and DRX cycle regarding the DRX information comprising minimum DRX cycle associated paging carrier as discussed above. In some embodiments, in the embodiment where selecting the first paging carrier only based on DRX cycle, terminal device may select the first paging carrier in the same way of the embodiment where selecting the first paging carrier only based on the DRX cycle regarding the DRX information comprising minimum DRX cycle associated paging carrier as discussed above.

In some embodiments, after terminal device 220 selected the first paging carrier, the target DRX cycle is determined by: DRX cycle=DRX cycle associated with the first paging carrier selected by terminal device 220.

FIG. 6 illustrates an example of DRX information comprising a plurality of DRX cycles associated with respective paging carriers according to example embodiments of the present disclosure.

In the example DRX information 600, without suggesting any limitation as to the scope of the disclosure, three DRX cycles associated with three paging carrier in the list, i.e., Carrier 3, 4 and 5, are shown, and Carrier 3, 4 and 5 may be associated with different coverage levels. Schematically, the corresponding CSS durations 610, 620 and 630 corresponding to these carriers is illustrated on the right. In exemplary embodiment of FIG. 6, assuming DRX cycles associated with Carrier 3, 4 and 5 are 320 ms, 640 ms and 1280 ms respectively, default DRX cycle of a cell associated with the terminal device 220 is 1280 ms and DRX cycle specific to terminal device 220 is 640 ms. Without any limitation, the value of DRX cycle associated with frequency resource, or the value of DRX cycle specified to terminal devices, or the value of the default DRX cycle of a cell in the present disclosure is only an example, and any other values of DRX cycle can be employed.

FIG. 7A-FIG. 7C illustrates examples of target DRX cycle determined based on at least one of DRX cycle associated with paging carrier, DRX cycle specific to a terminal device according to example embodiments of the present disclosure.

FIG. 7A illustrates the relation between the CSS of selected paging carrier-Carrier 5 and the determined DRX cycle in the embodiment where selecting the first paging carrier only based on the coverage level associated with the terminal device 220. In FIG. 7A, in the schematic diagram 700, the terminal device 220 may monitor at the PO on the first paging carrier, Carrier 5, with the determined target DRX cycle, 1280 ms, such that avoiding the overlapping between the CSSs belonging to adjacent DRX cycles.

FIG. 7B illustrates the relation between the CSS of selected paging carrier-Carrier 4 and the determined DRX cycle in the embodiment where selecting the first paging carrier based on the coverage level associated with the terminal device 220 and the DRX cycle specified to the terminal device 220. In FIG. 7B, in the schematic diagram 710, the terminal device 220 may monitor at the PO on the first paging carrier, Carrier 4, with the determined target DRX cycle, 640 ms, such that avoiding the overlapping between the CSSs belonging to adjacent DRX cycles.

FIG. 7C illustrates the relation between the CSS of selected paging carrier-Carrier 4 and the determined DRX cycle in the embodiment where selecting the first paging carrier only based on the DRX cycle specified to the terminal device 220. In FIG. 7C, the terminal device 220 may monitor at the PO on the first paging carrier, Carrier 4, with the determined target DRX cycle, 640 ms, such that avoiding the overlapping between the CSSs belonging to adjacent DRX cycles.

According to embodiments of present disclosure, a method implemented at terminal device for alignment between terminal device and network device is provided. In this method, terminal device and network device align with each other for the first criteria of frequency resource selection.

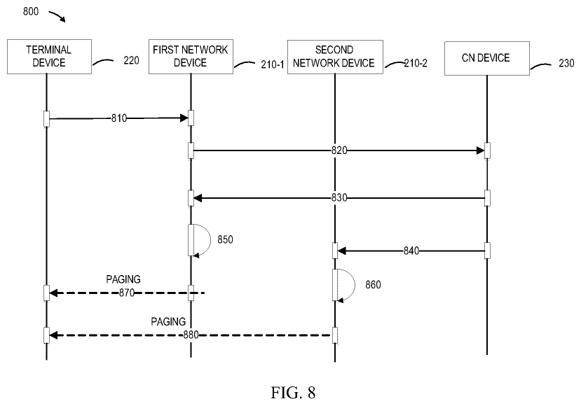

For the purpose of discussion, this method will be discussed with reference to FIG. 8. Signaling diagram 800 shown in FIG. 8 illustrates an example alignment between a terminal device, network devices and a core network according to example embodiments of the present disclosure. In FIG. 8, terminal device 220, first network device 210-1, second network device 210-2 and a CN device 230 are shown. Only for the purpose of illustration, first network device 210-1 and second network device 210-2 represent the multiple network devices paging terminal device 220. The CN device 230 may communicate the terminal device 220 via the first network device 210-1 or the second network device 210-2 or other network devices.

According to embodiments of present disclosure, terminal device 220 selects (810) a paging carrier from a plurality of paging carriers based on a first criteria. Then, terminal device 220 sends (820) a first indication of the first criteria to the first network device 210-1.

In some embodiments, the first criteria is related to selecting the first frequency resource from a plurality of frequency resources based on a coverage level associated with the terminal device, or a DRX cycle specific to the terminal device, or the coverage level associated with the terminal device and the DRX cycle specific to the terminal device.

In some embodiments, the first indication may indicates that terminal device 220 selects a first paging carrier from a plurality of paging carriers only based on coverage level. In some embodiments, the first criteria may indicates that terminal device 220 selects the first paging carrier from a plurality of paging carriers based on coverage level and DRX cycle. In some embodiments, the first criteria may indicates that terminal device 220 selects the first paging carrier from a plurality of paging carriers only based on DRX cycle.

In an exemplary embodiment, the first indication may be of an indicator format consists of one bit. In this case, the first indication represents the first paging carrier is selected only based on the coverage level associated with the terminal device 220 when the indicator format is “0”. Further, the first indication represents the first paging carrier is selected based on coverage level associated with the terminal device 220 and the DRX cycle specified to the terminal device 220 when the indicator format is “1”.

Alternatively, the first indication may also be of an indicator consists of two bits. In this case, the first indication represents the first paging carrier is selected only based on coverage level associated with the terminal device 220 when the indicator format is “00”. Further, the first indication represents the first paging carrier is selected based on coverage level associated with the terminal device 220 and the DRX cycle specified to the terminal device 220 when the indicator format is “01”. Further, the first indication represents the first paging carrier is selected only based on the DRX cycle specified to the terminal device 220 when the indicator format is “10”. The above formats of the first indication are only examples and any format capable of representing selection criteria of frequency resource can be employed as the first indication.

In some embodiments, terminal device 301 may determine a discontinuous reception (DRX) cycle based on a second criteria. Then, terminal device 301 also sends a second indication to first network device 210-1. In some embodiments, the first indication and second indication may be sent in the same signaling to first network device 210-1.

In some embodiments, the second indication may indicate that the determination criteria in which terminal device determines the target DRX cycle, for example, terminal device determines the target DRX cycle in a similar way of the embodiment where determining the target DRX cycle based on the minimum DRX cycle associated with the first paging carrier or the embodiment where determining the DRX cycle based on the DRX cycle associated with the first paging carrier.

In some embodiments, the first network device 210-1 sends (830) the first indication to CN device 230. For example, the first network device 210-1 sends the first indication in the ue-RadioPagingInfo information element to the CN device 230. For example, this information element is sent to the CN device 230 at the same time as the network device 210 uploads the UE Radio Capability information. The CN device 230 stores the UE Radio Capability for Paging Information in the MME context. When it needs to page, the CN device 230 provides the UE Radio Capability for Paging Information for that RAT to the network device 210 as part of the S1 paging message. Then, the network device 210 may use the UE Radio Capability for Paging Information to enhance the paging for the terminal device 220.

In some embodiments, the first network device 210-1 also sends (830) the second indication to CN device 230. In some embodiments, CN device 230 sends (840, 850) the first indication to the first network device 210-1 and second network device 210-2, such that these network devices know the paging selection criteria of terminal device 220. In some embodiments, CN device 230 sends (840, 850) the second indication to the first network device 210-1 and second network device 210-2, such that these network devices know the DRX cycle determination criteria of terminal device 220. In some embodiments, CN device 230 sends (840, 850) the first and second indication to the network devices paging terminal device 301 in S1 interface paging message.

In some embodiments, based on the first indication, the first and second network devices 210-1 and 210-2, are able to determine the same first paging carrier as selected by the terminal device 220. In some embodiments, with predetermined rules, after selecting the paging carrier for the terminal device, these network devices may determine the same target DRX cycle for terminal device as target DRX cycle determined by terminal device. Therefore, network device and terminal device can align with each other by means of the first indication.

In some embodiments, after selecting the paging carrier for the terminal device, these network devices 210-1 and 210-2 may determine the same target DRX cycle as determined by the terminal device 220 based on the received second indication. In some embodiments, the second criteria is related to at least one of a minimum DRX cycle associated with the first paging carrier and a DRX cycle associated with the first frequency resource.

Therefore, network device and terminal device can align with each other by means of the first indication. Further, these network devices 210-1 and 210-2 may paging (880, 890) for terminal device on the selected paging carrier with the determined DRX cycle, and the terminal device 220 monitors the first frequency resource, and the first frequency resource is selected from a plurality of frequency resources based on the first criteria. Please note that, the above steps can be performed in parallel, in order, and in reverse order in time.

According to embodiments of present disclosure, a method implemented at network device for alignment between terminal device and network device is provided. In this method, terminal device and network device align with each other for the first criteria of paging selection.

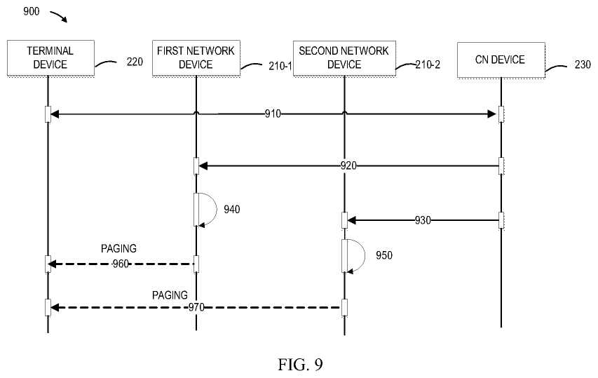

For the purpose of discussion, this method will be discussed with reference to FIG. 9. Signaling diagram 900 shown in FIG. 9 illustrates an example alignment between a terminal device, network devices and a core network according to example embodiments of the present disclosure. In FIG. 9, terminal device 220, first network device 210-1, second network device 210-2 and a CN device 230. Only for the purpose of illustration, first network device 210-1 and second network device 210-2 represent the multiple network devices paging terminal device 220. The terminal device 220 may communicate CN device 230 via first network device 210-1 or second network device 210-2 or other network devices.

In some embodiments, terminal device 220 negotiates (910) with CN device 230 on a first criteria used by terminal device 220 to select a paging carrier from a plurality of paging carriers. In some embodiments, terminal device 220 negotiates (910) with CN device 230 on a second criteria used by terminal device 220 to determine a DRX cycle.

In an exemplary embodiment, for the terminal device 220, the network device 210 broadcasts an indication of support of DRX cycle specific to the terminal device 220 in the cell of network device 210, and the terminal device 220 can request the DRX specific to the terminal device 220 during Attach and Tracking Area Update procedures irrespective of whether the cell broadcasts that support indication. The CN device 230 shall accept the DRX cycle proposed by the terminal device 220 for WB-E-UTRAN. For NB-IoT, the CN device 230 should accept the terminal device 220 requested DRX cycle. In other scenarios, subject to operator policy, the CN device 230 may change the terminal device 220 requested DRX cycle. Then, The CN device 230 shall respond to the UE with the Accepted DRX cycle.

In some embodiments, CN device 230 sends (920, 930) the first indication to the first network device 210-1 and the second network device 210-2, such that these network devices know the paging selection criteria of terminal device 220.

In some embodiments, CN device 230 sends (920, 930) the second indication to the first network device 210-1 and second network device 210-2, such that these network devices know the DRX cycle determination criteria of terminal device 220. In some embodiments, CN device 230 sends (840, 850) the first and second indication to the network devices paging terminal device 301 in S1 interface paging message.

In an exemplary embodiment, in each S1 interface Paging message, the CN device 230 sends the first indication to the network device 210 currently associated with the terminal device 220 (to help determine the DRX cycle specific to the terminal device 220) and information derived the first indication (which defines when the terminal device 220 will be awake from its sleep mode).

In some embodiments, the first indication may indicates that terminal device 220 selects a first paging carrier from a plurality of paging carriers only based on coverage level. In some embodiments, the first criteria may indicates that terminal device 220 selects the first paging carrier from a plurality of paging carriers based on coverage level and DRX cycle. In some embodiments, the first criteria may indicates that terminal device 220 selects the first paging carrier from a plurality of paging carriers only based on DRX cycle. In this embodiment, for example, in each S1 interface Paging message, if network device find that the DRX cycle specific to the terminal device 220 is included, for both terminal device 220 and network device 210, the paging carrier should be selected based on coverage level and DRX cycle.

In this way, in the situation in which the DRX cycle specific to the terminal device 220 has been agreed between the terminal device 220 and the CN device 230, the selection of the paging carriers for the terminal device 220 may be further based on the DRX cycle specific to the terminal device 220 in addition to the coverage level associated with the terminal device 220. As such, it facilitates to select a more appropriate first paging carrier for the terminal device 220.

In some embodiments, the second indication may indicate that the way in which terminal device 220 determines DRX cycle, for example, terminal device determines DRX cycle in a similar way of the embodiments where selecting the first paging carrier only based on the coverage level associated with the terminal device 220, or selecting the first paging carrier based on the coverage level associated with the terminal device 220 and the DRX cycle specific to the terminal device 220, or selecting the first paging carrier only based on the DRX cycle specific to the terminal device 220, and will not be described in detail.

According to embodiments of present disclosure, the first network device 210-1 and the second network device 210-2 determine (940, 950) a first criteria used by a terminal device to select a paging carrier from a plurality of paging carriers. Then, network device selects (940, 950) the first paging carrier from the plurality of paging carriers based on the first criteria for the terminal device 220.

In some embodiments, the first and second network devices 210-1 and 210-2, based on the first indication, may determine the same first paging carrier as selected by the terminal device 220. In some embodiments, with predetermined rules, after selecting the first paging carrier for the terminal device, these network devices may determine the same DRX cycle for terminal device 220 as DRX cycle determined by the terminal device 220. Therefore, network device and terminal device can align with each other by means of the first indication.

In some embodiments, determining the first criteria comprises: in response to allocating a discontinuous reception (DRX) cycle specific to the terminal device, determining that the first criteria is to select a first frequency resource from the plurality of frequency resources based on a coverage level associated with the terminal device, or a DRX cycle specific to the terminal device, or the coverage level associated with the terminal device and the DRX cycle specific to the terminal device.

In some embodiments, the method further comprises receiving a second indication of a second criteria for determining a discontinuous reception (DRX) cycle for the terminal device. In some embodiments, the second criteria is related to at least one of a minimum DRX cycle associated with the first frequency paging carrier or a DRX cycle associated with the first paging carrier. Please note that, the above steps can be performed in parallel, in order, and in reverse order in time.

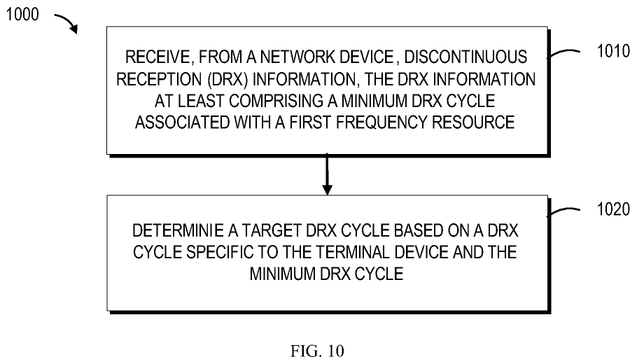

FIG. 10 illustrates a flowchart of an example method 1000 of communication implemented at a terminal device in accordance with some embodiments of the present disclosure. The method 1000 can be implemented at the terminal device 220 shown in FIG. 2. For the purpose of discussion, the method 1000 will be described with reference to FIG. 2. It is to be understood that the method 1000 may include additional acts not shown and/or may omit some shown acts, and the scope of the present disclosure is not limited in this regard.

As shown in FIG. 10, at block 1010, the terminal device 220 receives, from a network device 210, DRX information, the DRX information at least comprising a minimum DRX cycle associated with a first frequency resource.

At block 1020, the terminal device 220 determines target DRX cycle based on a DRX cycle specific to the terminal device and the minimum DRX cycle.

In some embodiments, wherein receiving the DRX information comprises: receiving, from the network device, a frequency resource list comprising one or more minimum DRX cycles associated with respective frequency resources.

In some embodiments, wherein receiving the DRX information comprises: receiving, from the network device, the DRX information in at least one of a System Information Block (SIB) or Radio Resource Control (RRC) signaling.

In some embodiments, wherein the DRX information comprises a plurality of minimum DRX cycles associated with a plurality of frequency resources, the method further comprising: determining the first frequency resource from the plurality of frequency resources based on at least one of a coverage level associated with the terminal device and the plurality of minimum DRX cycles.

In some embodiments, wherein the DRX information comprises a plurality of minimum DRX cycles associated with a plurality of frequency resources, the method further comprising: determining, from the plurality of frequency resources, a set of frequency resources based on the coverage level associated with the terminal device; and selecting the first frequency resource from the set of frequency resources.

In some embodiments, the terminal device 220 selects the first paging carrier from the set of paging carriers comprises: randomly selecting one of the set of frequency resources as the first frequency resource.

In some embodiments, wherein selecting the first frequency resource from the set of frequency resources comprises: selecting the first frequency resource from the set of frequency resources, a difference between the minimum DRX cycle associated with the first frequency resource and the DRX cycle specific to the terminal device being below a threshold.

In some embodiments, wherein the minimum DRX cycle associated with the first frequency resource is equal to or shorter than the DRX cycle specific to the terminal device, and determining the target DRX cycle comprises: selecting the target DRX cycle from the DRX cycle specific to the terminal device and a default DRX cycle.

In some embodiments, wherein determining the target DRX cycle comprises: determining a maximum of the DRX cycle specific to the terminal device and the minimum DRX cycle associated with the first frequency resource; and determining a minimum of a default DRX cycle and the determined maximum as the target DRX cycle.

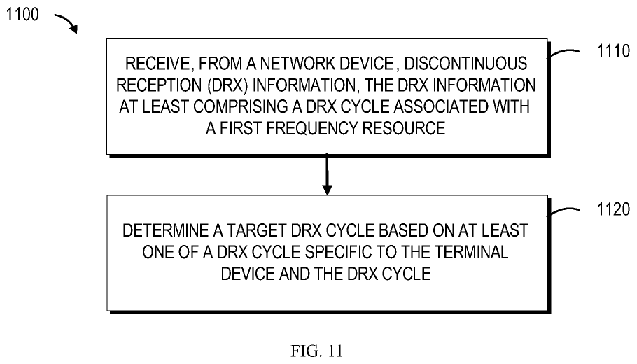

FIG. 11 illustrates a flowchart of an example method 1100 of communication implemented at a terminal device in accordance with some embodiments of the present disclosure. The method 1100 can be implemented at the terminal device 220 shown in FIG. 2. For the purpose of discussion, the method 1100 will be described with reference to FIG. 2. It is to be understood that the method 1100 may include additional acts not shown and/or may omit some shown acts, and the scope of the present disclosure is not limited in this regard.

As shown in FIG. 11, at block 1110, the terminal device 220 receives from a network device 210, DRX information, the DRX information at least comprising a DRX cycle associated with a first frequency resource.

At block 1130, the terminal device 220 determines a target DRX cycle based on at least one of a DRX cycle specific to the terminal device and the DRX cycle.

In some embodiments, wherein receiving the DRX information comprises: receiving, from the network device, a frequency resource list comprising, one or more DRX cycles associated with respective frequency resources.

In some embodiments, wherein receiving the DRX information comprises: receiving, from the network device, the DRX information in at least one of a System Information Block (SIB) or Radio Resource Control (RRC) signaling.

In some embodiments, wherein the DRX information comprises a plurality of DRX cycles associated with a plurality of frequency resources, the method further comprising: determining the first frequency resource from the plurality of frequency resources based on at least one of a coverage level associated with the terminal device and the plurality of DRX cycles.

In some embodiments, wherein the DRX information comprises a plurality of DRX cycles associated with a plurality of frequency resources, the method further comprising: determining, from the plurality of frequency resources, a set of frequency resources based on the coverage level associated with the terminal device; and selecting the first frequency resource from the set of frequency resources.

In some embodiments, wherein selecting the first frequency resource from the set of frequency resources comprises: randomly selecting one of the set of frequency resources as the first frequency resource.

In some embodiments, wherein selecting the first frequency resource from the set of frequency resources comprises: selecting the first frequency resource from the set of frequency resources, a difference between the DRX cycle associated with the first frequency resource and the DRX cycle specific to the terminal device being below a threshold.

In some embodiments, wherein the DRX cycle associated with the first frequency resource is equal to or shorter than the DRX cycle specific to the terminal device, and determining the target DRX cycle comprises: selecting the DRX cycle associated with the first frequency resource as the target DRX cycle.

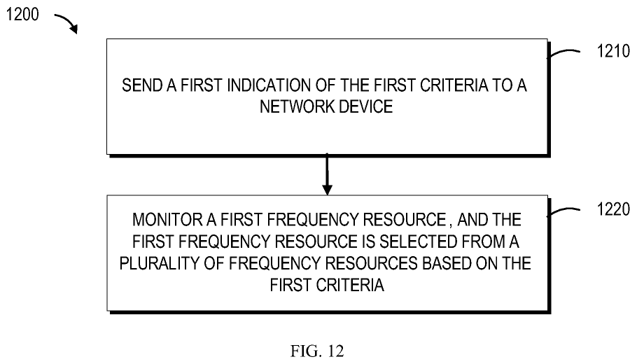

FIG. 12 illustrates a flowchart of an example method 1200 of communication implemented at a terminal device in accordance with some embodiments of the present disclosure. The method 1200 can be implemented at the terminal device 220 shown in FIG. 2. For the purpose of discussion, the method 1200 will be described with reference to FIG. 2. It is to be understood that the method 1200 may include additional acts not shown and/or may omit some shown acts, and the scope of the present disclosure is not limited in this regard.

At block 1210, the terminal device 220 sends a first indication of the first criteria to a network device 210-1.

At block 1220, the terminal device 220 monitors a first frequency resource, and the first frequency resource is selected from a plurality of frequency resources based on the first criteria.

In some embodiments, wherein the first criteria is related to selecting the first frequency resource from a plurality of frequency resources based on a coverage level associated with the terminal device, or a DRX cycle specific to the terminal device, or the coverage level associated with the terminal device and the DRX cycle specific to the terminal device.

In some embodiments, the method further comprises sending a second indication of the second criteria to the network device; and determining a discontinuous reception (DRX) cycle based on a second criteria.

In some embodiments, wherein the second criteria is related to at least one of a minimum DRX cycle associated with the first frequency resource or a DRX cycle associated with the first frequency resource.

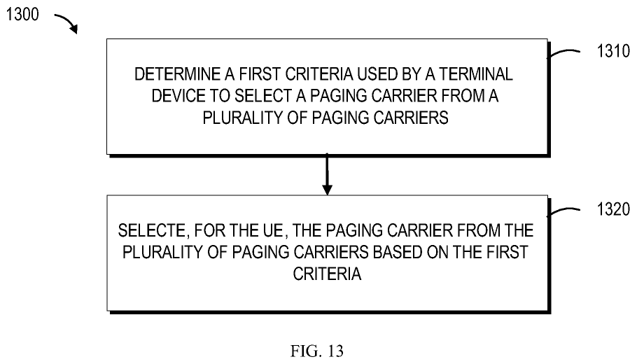

FIG. 13 illustrates a flowchart of an example method 1300 of communication implemented at a network device in accordance with some embodiments of the present disclosure. The method 1300 can be implemented at the network device 210-1/210-2 shown in FIG. 2. For the purpose of discussion, the method 1300 will be described with reference to FIG. 2. It is to be understood that the method 1300 may include additional acts not shown and/or may omit some shown acts, and the scope of the present disclosure is not limited in this regard.

At block 1310, the network device 210-1 determines a first criteria used by a terminal device to select a paging carrier from a plurality of paging carriers.

At block 1320, the network device 210-1 selects, for the terminal device, the paging carrier from the plurality of paging carriers based on the first criteria

In some embodiments, wherein determining the first criteria comprises: receiving a first indication of the first criteria from the terminal device; and determining the first criteria based on the first indication.

In some embodiments, the method further comprises sending the first indication of the first criteria to a CN 230.

In some embodiments, the network device 210-1 determines the first criteria comprises: in response to allocating a discontinuous reception (DRX) cycle specific to the terminal device, determining that the first criteria is to select the paging carrier from the plurality of paging carriers based on a coverage level associated with the terminal device, or a DRX cycle specific to the terminal device, or the coverage level associated with the terminal device and the DRX cycle specific to the terminal device.

In some embodiments, the method further comprises receiving a second indication of a second criteria for determining a discontinuous reception (DRX) cycle for the terminal device.

In some embodiments, wherein the second criteria is related to at least one of a minimum DRX cycle associated with the paging carrier or a DRX cycle associated with the first frequency resource.

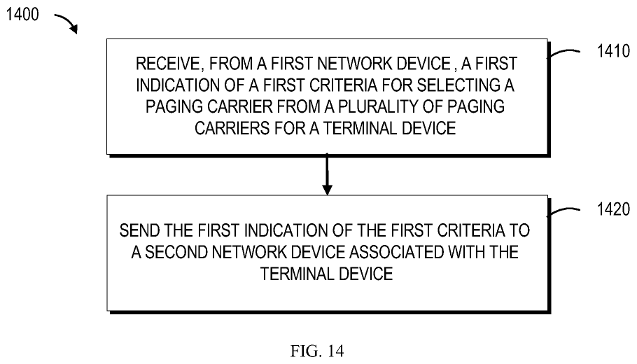

FIG. 14 illustrates a flowchart of an example method 1400 of communication implemented at a CN device in accordance with some embodiments of the present disclosure. The method 1200 can be implemented at the CN device 230 shown in FIG. 2. For the purpose of discussion, the method 1400 will be described with reference to FIG. 2. It is to be understood that the method 1400 may include additional acts not shown and/or may omit some shown acts, and the scope of the present disclosure is not limited in this regard.

At block 1410, the CN device 230 receives, from a first network device 210-1, a first indication of a first criteria for selecting a paging carrier from a plurality of paging carriers for a terminal device.

At block 1420, the CN device 230 sends the first indication of the first criteria to a second network device associated with the terminal device

In some embodiments, the method further comprises: receiving, from the first network device 210-1, a second indication of a second criteria for determining a discontinuous reception (DRX) cycle for the terminal device; and sending the second indication of the second criteria to the second network device.

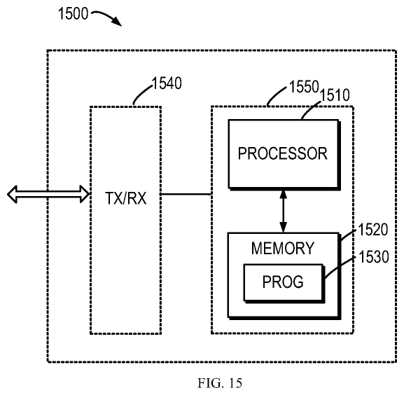

FIG. 15 is a simplified block diagram of a device 1500 that is suitable for implementing some embodiments of the present disclosure. The device 1500 can be considered as a further example embodiment of the network device 210 as shown in FIG. 8 or the equipment device 310 as shown in FIG. 3. Accordingly, the device 1500 can be implemented at or as at least a part of the network device 210 or the terminal device 220.

As shown, the device 1500 includes a processor 1010, a memory 1520 coupled to the processor 1510, a suitable transmitter (TX) and receiver (RX) 1540 coupled to the processor 1510, and a communication interface coupled to the TX/RX 1540. The memory 1520 stores at least a part of a program 1030. The TX/RX 1540 is for bidirectional communications. The TX/RX 1040 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1530 is assumed to include program instructions that, when executed by the associated processor 1510, enable the device 1500 to operate in accordance with the embodiments of the present disclosure, as discussed herein with reference to FIGS. 2 to 14. The embodiments herein may be implemented by computer software executable by the processor 1510 of the device 1500, or by hardware, or by a combination of software and hardware. The processor 1510 may be configured to implement various embodiments of the present disclosure. Furthermore, a combination of the processor 1510 and memory 1520 may form processing means 1550 adapted to implement various embodiments of the present disclosure.

The memory 1520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1520 is shown in the device 1500, there may be several physically distinct memory modules in the device 1500. The processor 1510 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a terminal device comprises circuitry configured to perform the method according to any one of method 1000, 1100 and 1200.

In some embodiments, a network device comprises circuitry configured to: perform the method according to any one of method 1300.

In some embodiments, a CN device comprises circuitry configured to: perform the method according to any one of method 1400.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniqterminal devices or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 3 to 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-33. (canceled)

34. A method, performed by a terminal device, the method comprising:
receiving, from a network device, a carrier list associated with at least one minimum discontinuous reception (DRX) cycle,
determining, from the carrier list, at least one carrier corresponding to a coverage level in a plurality of coverage levels for carrier selection, and
determining a target DRX cycle for paging based on a DRX cycle specific to the terminal device, a minimum DRX cycle within the at least one minimum DRX cycle associated with the coverage level, and a default DRX cycle.

35. The method of claim 34, wherein the receiving, from the network device, the carrier list associated with the at least one minimum DRX cycle comprises:
receiving, via a System Information Block (SIB), the carrier list associated with the at least one minimum DRX cycle.

36. The method of claim 34, wherein
each carrier of the carrier list is associated with one minimum DRX cycle of the at least one minimum DRX cycle.

37. The method of claim 34, further comprising:
determining a carrier for paging from the at least one carrier based on the coverage level.

38. A method, performed by a network device, the method comprising:
transmitting, to a terminal device, a carrier list associated with at least one minimum discontinuous reception (DRX) cycle, wherein the carrier list comprises at least one carrier corresponding to a coverage level in a plurality of coverage levels for carrier selection, and wherein a target DRX cycle for paging is based on a DRX cycle specific to the terminal device, a minimum DRX cycle within the at least one minimum DRX cycle associated with the coverage level, and a default DRX cycle; and
performing paging with the target DRX cycle.

39. The method of claim 38, wherein the transmitting, to the terminal device, the carrier list associated with the at least one minimum DRX cycle comprises:
transmitting, via a System Information Block (SIB), the carrier list associated with the at least one minimum DRX cycle.

40. The method of claim 38, wherein
each carrier of the carrier list is associated with one minimum DRX cycle of the at least one minimum DRX cycle.

41. The method of claim 38, wherein:
a carrier for paging is from the at least one carrier based on the coverage level.

42. A terminal device, comprising a processor configured to cause the terminal device to:
receive, from a network device, a carrier list associated with at least one minimum discontinuous reception (DRX) cycle,
determine, from the carrier list, at least one carrier corresponding to a coverage level in a plurality of coverage levels for carrier selection, and
determine a target DRX cycle for paging based on a DRX cycle specific to the terminal device, a minimum DRX cycle within the at least one minimum DRX cycle associated with the coverage level, and a default DRX cycle.

43. The terminal device of claim 42, wherein the processor is configured to cause the terminal device to receive, from the network device, the carrier list associated with the at least one minimum DRX cycle by:
receiving, via a System Information Block (SIB), the carrier list associated with the at least one minimum DRX cycle.

44. The terminal device of claim 42, wherein
each carrier of the carrier list is associated with one minimum DRX cycle of the at least one minimum DRX cycle.

45. The terminal device of claim 42, wherein the processor is further configured to cause the terminal device to:
determine a carrier for paging from the at least one carrier based on the coverage level.
